(19) United States
(12) Patent Application Publication
(10) Pub. No.: US 2024/0369115 A1
(43) Pub. Date: Nov. 7, 2024

(54) DRUM BRAKE

(71) Applicant: HL MANDO CORPORATION, Pyeongtaek (KR)

(72) Inventor: Hatem SHAHIN, Pfaffenhofen (DE)

(21) Appl. No.: 18/429,563

(22) Filed: Feb. 1, 2024

(30) Foreign Application Priority Data
May 2, 2023 (DE) 102023111208.2

(51) Int. Cl. F16D 65/00; F16D 65/04; F16D 69/04

(52) U.S. Cl. CPC F16D 65/0068; F16D 65/04; F16D 69/04

(57) ABSTRACT

The disclosed drum brake includes a brake disc configured to rotate together with a wheel, an inner brake pad and an outer brake pad arranged on both sides of the brake disc, a pressing member configured to press the inner brake pad toward the brake disc, and a caliper housing provided such that the pressing member moves forward or rearward, wherein the brake disc includes a hub part connected to an axle, a friction part provided in contact with the brake pads and disposed to be spaced a predetermined distance from the hub part in an axial direction, and an accommodation part which is formed between an inner surface of the hub part and an outer surface of the friction part and in which at least a portion of the outer brake pad is accommodated.

### CROSS-REFERENCE TO RELATED APPLICATION

This application claims the benefit of German Patent Application No. 102023111208.2, filed on May 2, 2023, in the German Patent Office (DPMA), the disclosures of which are incorporated herein by reference in its entirety.

### BACKGROUND

### 1. Technical Field

Embodiments of the present disclosure relate to a drum brake, and more particularly, to a lightweight drum brake.

### 2. Description of the Related Art

In general, vehicles necessarily include brake systems for braking. Representative brake systems include a drum brake and a caliper brake. The drum brake includes a drum configured to rotate together with wheels and a brake shoe having a lining (a frictional material) attached thereto, and when the vehicle is braked, the brake shoe is pressed from an inside of the drum to an inner circumferential surface of the drum to generate a frictional force and use the frictional force as a braking force.

In general, the drum included in the drum brake is made of a heavy material such as cast iron. Thus, the drum brake is heavier than the caliper brake. Accordingly, the drum brake according to the related art has many advantages compared to the caliper brake but has a fatal disadvantage that the drum brake makes the vehicle heavy. As a result, a high output power of a vehicle engine is required, fuel efficiency of the vehicle increases, and marketability of the vehicle is degraded.

The drum of the drum brake directly rubs against the brake shoe to generate the frictional force used as the braking force of the vehicle. Thus, a method for supplementing the disadvantages of the drum brake according to the related art, in which the weight of the drum is reduced while stably securing durability of the drum, is needed.

### SUMMARY

Therefore, it is an aspect of the present disclosure to provide a lightweight drum brake.

It is another aspect of the present disclosure to provide a drum brake configured to maintain durability while the drum brake is lightweight.

It is still another aspect of the present disclosure to provide a drum brake in which detailed components of the drum brake can be easily assembled and replaced.

It is yet another aspect of the present disclosure to provide a drum brake configured to increase fuel efficiency of a vehicle and improve marketability of the vehicle.

Additional aspects of the disclosure will be set forth in part in the description which follows and, in part, will be obvious from the description, or may be learned by practice of the disclosure.

In accordance with one aspect of the present disclosure, a drum brake provided with a drum that is in contact with a brake shoe to generate a frictional force includes a cylindrical body part having one open side and a friction part coupled to an inner circumferential surface of the body part to be in contact with the brake shoe, and a material for forming the body part is lighter than a material for forming the friction part.

The body part may include a cavity interposed between an outer circumferential surface and the inner circumferential surface thereof such that a space is formed therein.

The body part may include a support member provided inside the cavity and having one end provided to support an inside of the outer circumferential surface of the body part and the other end provided to support an outside of the inner circumferential surface of the body part.

The material for forming the friction part may include at least one of cast iron or ceramic.

The material for forming the body part may include at least one of aluminum, phenolic resin, or plastic.

The friction part may be provided as a plurality of friction parts.

The friction parts may be arranged to be spaced apart from each other in an axial direction of the body part.

The body part may include a recessed groove recessed in the inner circumferential surface thereof, and the friction part may include a protrusion unit protruding toward the body part so that the protrusion unit is inserted into the recessed groove.

The protrusion unit may be press-fitted into the recessed groove.

The body part may include a through-hole passing through the body part from the inner circumferential surface to the outer circumferential surface of the body part, and the friction part may include a protrusion unit protruding toward the body part to pass through the through-hole.

The protrusion unit may have a screw thread-shaped outer surface and may further include a nut coupled to a distal end of the protrusion unit.

The friction part may be adhesively coupled to the body part through an adhesive.

The support member may be provided as a plurality of support members.

The support members may be arranged to be spaced apart from each other along an outside of the inner circumferential surface of the body part.

The support members may be arranged to be radially symmetrical to each other with respect to an axis of the body part.

The support member may be made of a material including at least one of aluminum, phenolic resin, or plastic.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a side cross-sectional view illustrating a drum brake according to a first embodiment of the present disclosure;

FIG. 2 is a front cross-sectional view illustrating the drum brake according to the first embodiment of the present disclosure;

FIG. 3 is a side cross-sectional view illustrating a drum brake including a plurality of friction parts according to a second embodiment of the present disclosure; and

FIG. 4 is a side cross-sectional view illustrating a drum brake having a screw coupling structure according to a third embodiment of the present disclosure.

### DETAILED DESCRIPTION OF EMBODIMENTS

Hereinafter, present embodiments will be described in detail with reference to the accompanying drawings. The following embodiments are presented to sufficiently transfer the spirit of the present disclosure to those skilled in the art to which the present disclosure pertains. The present disclosure is not limited to the embodiments presented herein and may be embodied in other forms. In the drawings, illustration of components irrelevant to the description will be omitted to clarify the present disclosure, and the sizes of the components may be slightly exaggerated to help understanding.

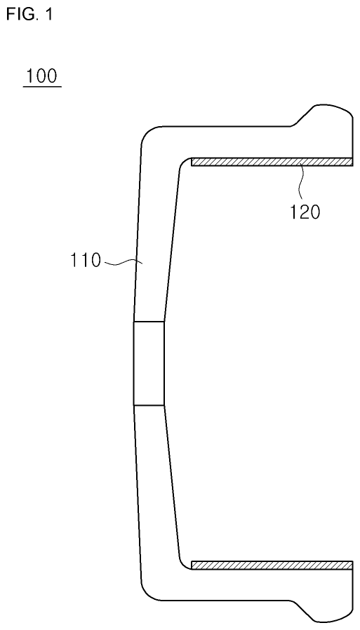

FIG. 1 is a side cross-sectional view illustrating a drum brake according to a first embodiment of the present disclosure.

Referring to FIG. 1, the drum brake according to the first embodiment of the present disclosure includes a drum 100 including a body part 110 and a friction part 120.

The drum 100 of the drum brake according to the related art has a portion coupled to a vehicle body and a portion in contact with a brake shoe (not illustrated), which are integrally provided. The drum brake may generate a stable frictional force to stably generate a braking force, and thus, the drum 100 in direct contact with the brake shoe (not illustrated) requires a certain level or more of durability.

Accordingly, the drum 100 according to the related art is made of a heavy material such as cast iron. The drum 100 made of a heavy material has strong durability but has a disadvantage that the weight of the drum brake is large. The heavy drum brake causes an increase in the weight of the entire vehicle and requires high output of an engine for driving the vehicle, resulting in degradation of fuel efficiency and marketability of the vehicle.

To solve this problem, embodiments of the present disclosure implement the lightweight drum 100. In detail, in the drum brake, the portion coupled to the vehicle body and the portion in contact with the brake shoe (not illustrated) are divided into two parts such as the body part 110 and the friction part 120, and thus the weight of the body part 110 is reduced while durability of the friction part 120 is maintained.

The body part 110 is provided in a cylindrical shape having one open side.

The friction part 120 is provided in contact with an inner circumferential surface of the body part 110. Thus, the friction part 120 is a part in direct contact with the brake shoe (not illustrated) to generate a frictional force. The friction part 120 may be coupled to the inner circumferential surface of the body part 110 through an adhesive.

In this case, the inner circumferential surface of the body part 110 is a surface of the body part 110, which faces in an axial direction of the cylindrical shape. In contrast, an outer circumferential surface of the body part 110 is a surface of the body part 110, which faces outward from the cylindrical shape not the axial direction of the cylindrical shape. Hereinafter, the inner circumferential surface or the outer circumferential surface of the body part 110 may be understood in the same meaning as above.

The friction part 120 may be made of a material including at least one of cast iron and ceramic. Thus, the friction part 120 has durability sufficient for withstanding friction generated through contact with the brake shoe (not illustrated). As an example, the thickness of the friction part 120 made of cast iron may be in a range of 0.4 mm to 0.6 mm, and the thickness of the friction part 120 made of ceramic may be in a range of 0.2 mm to 0.3 mm.

The body part 110 implements the lightweight of the drum 100 in terms of a material or structure.

The body part 110 may be made of a material lighter than a material for forming the friction part 120. As an example, the body part 110 may be made of a material including at least one of aluminum, phenolic resin, or plastic.

However, in the first embodiment of the present disclosure, the material of the friction part 120 is not limited to the material including at least one of cast iron or ceramic, and the material of the body part 110 is not limited to the material including at least one of aluminum, phenolic resin, or plastic. Further, all the drums 100 in which the body part 110 is formed of a relatively lighter material than the friction part 120 so that the weight of the entire drum 100 is reduced are included.

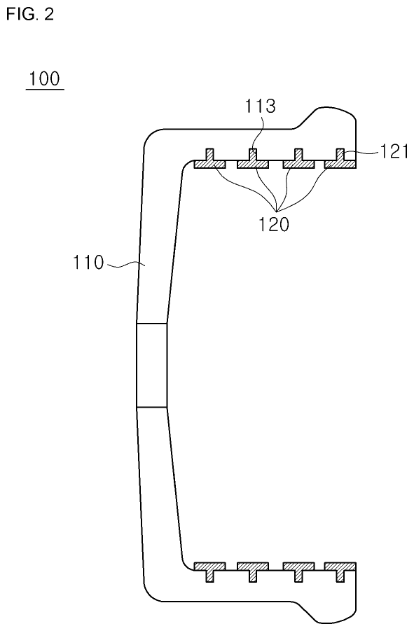

FIG. 2 is a front cross-sectional view illustrating the drum brake according to the first embodiment of the present disclosure.

Referring to FIG. 2, in the drum brake according to the first embodiment of the present disclosure, the body part 110 includes a cavity 111 and a support member 112.

The cavity 111 is a space provided inside the body part 110. In this case, the inside of the body part 110 is a space between the outer circumferential surface and the inner circumferential surface of the body part 110. That is, the cavity 111 is interposed between the outer circumferential surface and the inner circumferential surface of the body part 110. Hereinafter, the inner surface of the body part 110 may be understood in the same meaning as above.

The support member 112 is provided inside the cavity 111 and has one end provided to support an inside of the outer circumferential surface of the body part 110 and the other end provided to support an outside of the inner circumferential surface of the body part 110. In this case, the inside is a surface in an axial direction of the cylindrical shape in the cylindrical body part 110. In contrast, the outside is a surface in an outward direction of the cylindrical shape not the axial direction of the cylindrical shape in the body part 110. Hereinafter, the inside and the outside may be understood in the same meaning as above.

Thus, the brake starts braking, and thus the brake shoe (not illustrated) pushes the friction part 120 outward. Further, even when the friction part 120 pushes the inner circumferential surface of the body part 110 outward, the inner circumferential surface may be supported by the support member 112 and thus withstand an external force caused by the brake shoe (not illustrated).

The support member 112 may be provided as a plurality of support members 112. The plurality of support members 112 may be arranged to be spaced apart from each other along the outside of the inner circumferential surface of the body part 110. The plurality of support members 112 may be radially symmetrical to each other with respect to an axis of the drum 100. When the number of support members 112 is large, the durability of the body part 110 increase, and when the number of support members 112 is small, the weight of the body part 110 decreases.

The support member 112 may be made of a light material like the body part 110. That is, the support member 112 may be made of a material including at least one of aluminum, phenolic resin, or plastic. In this case, the weight of the body part 110 may decrease.

In contrast, the support member 112 may be made of a heavy material like the friction part 120. That is, the support member 112 may be made of a material including at least one of cast iron and ceramic. In this case, the durability of the body part 110 may increase.

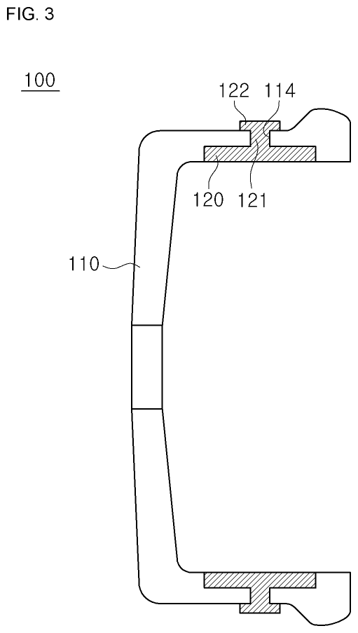

FIG. 3 is a side cross-sectional view illustrating a drum brake including a plurality of friction parts 120 according to a second embodiment of the present disclosure.

Referring to FIG. 3, a drum brake according to the second embodiment of the present disclosure includes a plurality of friction parts 120, a plurality of recessed grooves 113, and a plurality of protrusion units 121.

The second embodiment of the present disclosure differs from the first embodiment of the present disclosure in terms of the number of friction parts 120 and a coupling structure in which the friction parts 120 are coupled to the body part 110. Contents other than those described using separate reference numerals according to the second embodiment may be understood as the same as those according to the first embodiment. Thus, to prevent a duplicated description, the same contents according to the second embodiment as those according to the first embodiment will be omitted.

The friction part 120 may be provided as a plurality of friction parts 120. In detail, as illustrated in FIG. 3, the plurality of friction parts 120 are formed such that a length of the friction parts 120 in an axial direction is smaller than a length of the inner circumferential surface of the body part 110 in the axial direction, and the plurality of friction parts 120 may be arranged to be spaced apart from each other in the axial direction of the body part 110. Thus, as areas of the friction parts 120 formed of a heavy material become smaller, the drum 100 may become lighter. Further, when some of the plurality of friction parts 120 are damaged, not all the friction parts 120 but only the damaged friction parts 120 may be replaced, and thus maintenance costs of the drum 100 can be saved.

The recessed groove 113 of the body part 110 is recessed inward of the body part 110 from the inner circumferential surface of the body part 110, and the protrusion unit 121 of the friction part 120 protrudes from a surface in contact with the inner circumferential surface of the body part 110 toward the body part 110 so that the protrusion unit 121 is inserted into the recessed groove 113. In this case, the protrusion unit 121 is press-fitted into the recessed groove 113 so that the friction part 120 may be fixed to the body part 110.

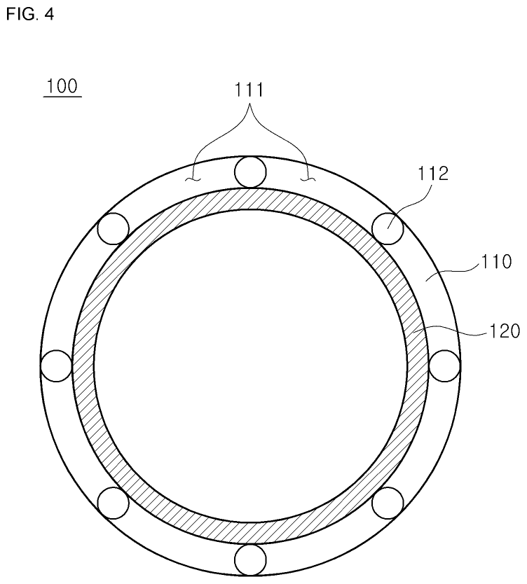

FIG. 4 is a side cross-sectional view illustrating a drum brake having a screw coupling structure according to a third embodiment of the present disclosure.

Referring to FIG. 4, a drum brake according to the third embodiment of the present disclosure includes a through-hole 144 and a nut 122.

The third embodiment of the present disclosure differs from the first embodiment of the present disclosure in terms of a coupling structure in which the friction parts 120 are coupled to the body part 110. Contents other than those described using separate reference numerals according to the third embodiment may be understood as the same as those according to the first embodiment. Thus, to prevent a duplicated description, the same contents according to the third embodiment as those according to the first embodiment will be omitted.

The through-hole 114 passes through the body part 110 from the inner circumferential surface to the outer circumferential surface of the body part 110. In this case, the protrusion unit 121 protrudes toward the body part 110 to pass through the through-hole 114. Thus, the protrusion unit 121 according to the third embodiment may be formed longer than the protrusion unit 121 of the first embodiment.

A screw thread may be formed on an outer surface of the protrusion unit 121, and the nut 122 may be coupled to a distal end of the protrusion unit 121. That is, when the protrusion unit 121 is inserted into the through-hole 114, the distal end of the protrusion unit 121 may protrude outward from the outer circumferential surface of the body part 110, and the nut 122 may be screw-coupled to the protruding distal end of the protrusion unit 121. Thus, the friction part 120 and the body part 110 can be firmly coupled, and the friction part 120 can be easily detached from and attached to the body part 110, thereby achieving easy assembling.

The drum brake according to an embodiment of the present disclosure having such a configuration includes the drum 100 divided in two parts including the body part 110 and the friction part, wherein the body part 110 may be formed of a lighter material than the friction part 120 so that the drum 100 can be lightweight while maintaining durability, the body part 110 may include the cavity 111 and the support member 112 so that the drum 100 can be lightweight while maintaining durability, the body part 110 may be provided with the recessed groove 133 or the through-hole 114, the friction part 120 may be provided with the protrusion unit 121 and additionally provided with the nut 122, and thus the friction part 120 can be easily assembled and replaced while being stably coupled to the body part 110. It is apparent that the lightweight drum brake can increase the fuel efficiency of the vehicle and improve the marketability of the vehicle.

As is apparent from the above description, according to an aspect of the present disclosure, a lightweight drum brake is provided.

According to another aspect of the present disclosure, a drum brake configured to maintain durability while the drum brake is lightweight is provided.

According to still another aspect of the present disclosure, a drum brake in which detailed components of the drum brake can be easily assembled and replaced is provided.

According to yet another aspect of the present disclosure, a drum brake configured to increase fuel efficiency of a vehicle and improves marketability of the vehicle is provided.

What is claimed is:

1. A drum brake comprising:
a brake disc configured to rotate together with a wheel;
an inner brake pad and an outer brake pad arranged on both sides of the brake disc;
a pressing member configured to press the inner brake pad toward the brake disc; and
a caliper housing provided such that the pressing member moves forward or rearward,
wherein the brake disc includes:
a hub part connected to an axle;
a friction part provided in contact with the brake pads and disposed to be spaced a predetermined distance from the hub part in an axial direction; and
an accommodation part which is formed between an inner surface of the hub part and an outer surface of the friction part and in which at least a portion of the outer brake pad is accommodated.

2. The drum brake of claim 1, wherein the caliper housing includes a cylindrical part installed such that the pressing member moves forward or rearward, a finger part configured to press the outer brake pad toward the brake disc, and a body part connecting the cylinder portion and the finger portion, and
the body part connects the cylinder part and the finger part at a lower side of the friction part.

3. The drum brake of claim 1, wherein the brake disc further includes a connection part having one side configured to support the hub part and the other side configured to support the friction part.

4. The drum brake of claim 3, further comprising a first connection pin configured to fix the connection part to the hub part.

5. The drum brake of claim 4, wherein the hub part includes a first hole axially passing through a distal end thereof,
the connection part is provided with a first accommodation groove recessed in a surface thereof in contact with the hub part, and
the first connection pin passes through the first hole and has a distal end seated on and supported by the first accommodation groove.

6. The drum brake of claim 5, wherein the first connection pin has a screw thread formed on an outer circumferential surface thereof, and
the first hole and the first accommodation groove have screw grooves, to which the screw thread is fastened, on inner circumferential surfaces thereof.

7. The drum brake of claim 5, wherein a distal end of the hub part, in which the first hole is formed, is made of a material having a higher strength than a central portion of the hub part.

8. The drum brake of claim 4, wherein the connection part includes:
a body unit in contact with the hub part; and
a protrusion unit protruding and extending from the body unit toward the friction part.

9. The drum brake of claim 8, wherein a thickness of the protrusion unit is smaller than a thickness of the body unit.

10. The drum brake of claim 3, further comprising a second connection pin configured to fix the connection part to the friction part.

11. The drum brake of claim 10, wherein the connection part includes a second hole passing through an end of the friction part in a direction perpendicular to an axis of the friction part,
the friction part is provided with a second accommodation groove recessed in a surface thereof in contact with the connection part, and
the second connection pin passes through the second hole and has a distal end seated on and supported by the second accommodation groove.

12. The drum brake of claim 11, wherein the second connection pin has a screw thread formed on an outer circumferential surface thereof, and
the second hole and the second accommodation groove have screw grooves, to which the screw thread is fastened, on inner circumferential surfaces thereof.

13. The drum brake of claim 5, wherein the first connection pin is press-fitted into the first hole and the first accommodation groove.

14. The drum brake of claim 11, wherein the second connection pin is press-fitted into the second hole and the second accommodation groove.

15. The drum brake of claim 5, wherein the first connection pin includes a first pin head formed at a distal end of the hub part in an outward direction and having a diameter greater than an inner diameter of the first hole.

16. The drum brake of claim 11, wherein the second connection pin includes a second pin head formed at a distal end of the connection part in an upward direction and having a diameter greater than an inner diameter of the second hole.
